(19) United States
(12) Patent Application Publication
(10) Pub. No.: US 2025/0158746 A1
(43) Pub. Date: May 15, 2025

(54) CSI REFINEMENT OR ADJUSTMENT AND PUCCH REPETITION

(71) Applicant: QUALCOMM Incorporated, San Diego, CA (US)

(72) Inventors: Mahmoud TAHERZADEH BOROUJENI, San Diego, CA (US); Qiaoyu LI, Beijing (CN); Tao LUO, San Diego, CA (US)

(21) Appl. No.: 18/839,368

(22) PCT Filed: Apr. 21, 2022
(86) PCT No.: PCT/CN2022/088097

§ 371 Date: Aug. 16, 2024

(51) Int. Cl. H04L 1/08; H04B 7/06; H04L 1/1812; H04L 5/00; H04W 72/1273

(52) U.S. Cl. CPC H04L 1/08; H04B 7/0626; H04L 1/1812; H04L 5/0048; H04W 72/1273

(57) ABSTRACT

A UE receives an indication of resources for physical uplink control channel (PUCCH) repetition associated with a physical downlink shared channel (PDSCH); transmits hybrid automatic repeat request (HARQ) feedback in a first subset of the resources for the PUCCH repetition associated with the PDSCH; and transmits channel state information (CSI) refinement information based on a demodulation reference signal (DMRS) measurement associated with the PDSCH in a second subset of the resources for the PUCCH repetition associated with the PDSCH.

### TECHNICAL FIELD

The present disclosure relates generally to communication systems, and more particularly, to wireless communication including channel state information (CSI) refinement or CSI adjustment and physical uplink control channel (PUCCH) repetition.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus receives an indication of resources for physical uplink control channel (PUCCH) repetition associated with a physical downlink shared channel (PDSCH); transmits hybrid automatic repeat request (HARQ) feedback in a first subset of the resources for the PUCCH repetition associated with the PDSCH; and transmits channel state information (CSI) refinement information based on a demodulation reference signal (DMRS) measurement associated with the PDSCH in a second subset of the resources for the PUCCH repetition associated with the PDSCH.

In another aspect of the disclosure, a method, a computer-readable medium, and an apparatus are provided for wireless communication at a network entity. The apparatus outputs an indication of resources for PUCCH repetition associated with a PDSCH for a UE, obtains HARQ feedback in a first subset of the resources for the PUCCH repetition associated with the PDSCH, and obtains CSI refinement information based on a DMRS measurement associated with the PDSCH in a second subset of the resources for the PUCCH repetition associated with the PDSCH.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 illustrates example aspects of beamformed communication between a UE and a base station.

FIG. 5 illustrates an example resource diagram for PDSCH and associated DMRS.

FIG. 6A and FIG. 6B illustrate examples of PUCCH repetition with a subset of resources for HARQ-ACK and a subset of resources for CSI refinement information.

FIG. 7 is a communication flow between a UE and a base station, in accordance with various aspects of the present disclosure.

FIG. 8A and FIG. 8B are flowcharts of a method of wireless communication at a UE, in accordance with various aspects of the present disclosure.

FIG. 9 is a diagram illustrating an example of a hardware implementation for an example apparatus and/or UE, in accordance with various aspects of the present disclosure.

FIG. 10A and FIG. 10B are flowcharts of a method of wireless communication at a network entity, in accordance with various aspects of the present disclosure.

FIG. 11 is a diagram illustrating an example of a hardware implementation for an example network entity, in accordance with various aspects of the present disclosure.

### DETAILED DESCRIPTION

A UE may measure and report CSI to a network. The network may use the reported CSI to adjust one or more communication parameters to improve communication with the UE. The CSI is based on a downlink reference signal that the UE is configured to measure for CSI purposes, such as a channel state information reference signal (CSI-RS) or a synchronization signal block (SSB). In some aspects, the UE may determine a CSI refinement or CSI adjustment based on another downlink reference signal. As one example, a CSI refinement may be based on a measurement of a demodulation reference signal (DMRS) of a downlink transmission, such as DMRS transmitted in a PDSCH transmission. Although the DMRS may be included in the PDSCH to assist the UE in decoding the PDSCH, the UE may use the DMRS to perform a CSI measurement, and may report the CSI to the network based on the measurement of the DMRS. The use of the DMRS to perform the CSI measurement and CSI refinement enables the UE to provide the network with refined, or adjusted, CSI information without additional overhead for an additional reference signal, such as CSI-RS or SSB, by using the DMRS that is transmitted with the PDSCH for decoding purposes.

In some aspects, the UE may report the CSI refinement information, e.g., based on the measurement of the DMRS, to the base station along with HARQ-ACK feedback for the PDSCH. If the CSI refinement information is transmitted together with the HARQ-ACK feedback, the overall size of the UCI that includes the HARQ-ACK feedback and the CSI refinement information is increased. The PUCCH resources that the UE is to use to transmit the UCI may be dependent on the size of the UCI. For example, there may be different PUCCH resource sets for different sizes of UCI. If the UE includes the CSI refinement information with the HARQ-ACK information, the UE may then transmit the resulting UCI in a different PUCCH resource set than the UE would use to transmit the UCI including the HARQ-ACK feedback and without the CSI refinement information, based on the increased size of the UCI. Additionally, for UEs in limited coverage, which may be referred to as coverage-limited UEs, separate transmissions of the CSI information (e.g., delta CQI or delta L1-RSRP) and HARQ-ACK feedback may provide improved accuracy of communication. For example, the separate transmissions may provide better coverage for the UE as the separate transmissions may have different coverage. As well, the separate transmissions may avoid decoding errors due to the combination of information carried in a combined UCI.

The UE may be indicated to provide PUCCH repetition to the network. Aspects presented herein provide for an interaction of CSI refinement/adjustment, which may be transmitted with HARQ-ACK information for a PDSCH, using different subsets of PUCCH repetition resources associated with the PDSCH. The use of different subsets of PUCCH repetition resources for HARQ-ACK and CSI refinement information may help to reduce the size of the UCI transmitted and may improve coverage of the transmissions through separating the HARQ-ACK information and the CSI refinement information. The method may provide for CSI with reduced overhead through the use of DMRS while avoiding a UCI size increase that may affect the PUCCH resources for the HARQ-ACK.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

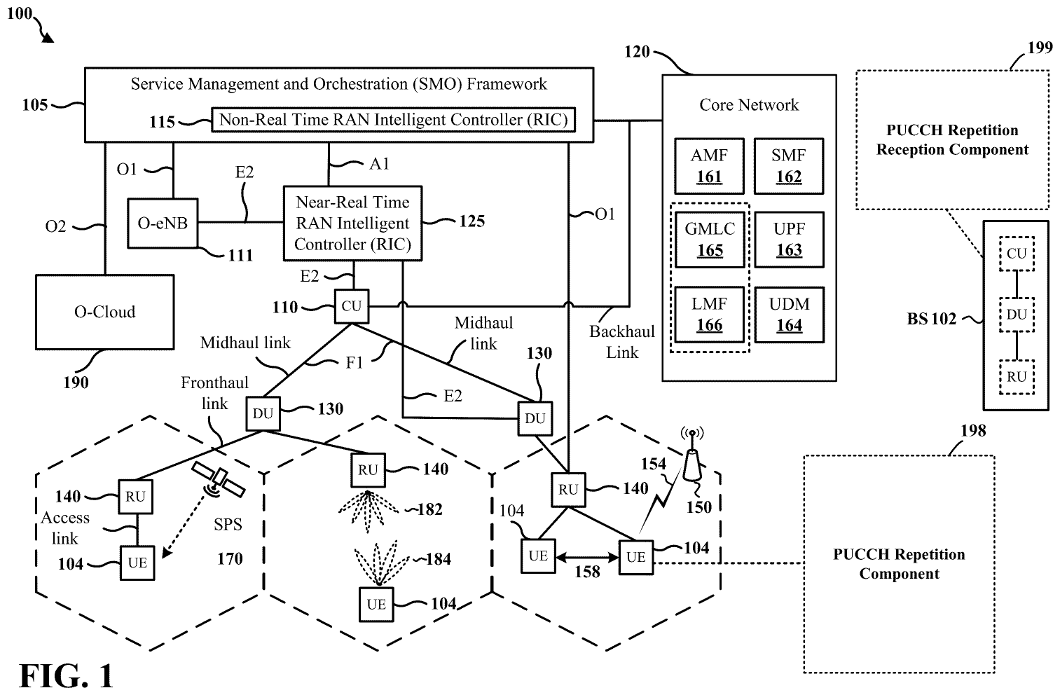

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers are illustrated as including a Gateway Mobile Location Center (GMLC) 165 and a Location Management Function (LMF) 166. However, generally, the one or more location servers may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a PUCCH repetition component 198 configured to receive an indication of resources for PUCCH repetition associated with a PDSCH, transmit HARQ feedback in a first subset of the resources for the PUCCH repetition associated with the PDSCH, and transmit CSI refinement information based on a DMRS measurement associated with the PDSCH in a second subset of the resources for the PUCCH repetition associated with the PDSCH.

In some aspects, the base station 102, or a component of a base station 102, may include a PUCCH repetition reception component 199 configured to output an indication of resources for PUCCH repetition associated with a PDSCH for a UE, obtain HARQ feedback in a first subset of the resources for the PUCCH repetition associated with the PDSCH, and obtain CSI refinement information based on a DMRS measurement associated with the PDSCH in a second subset of the resources for the PUCCH repetition associated with the PDSCH. Although the following description may be focused on 5G NR, the concepts described herein may be applicable to other similar areas, such as LTE, LTE-A, CDMA, GSM, and other wireless technologies.

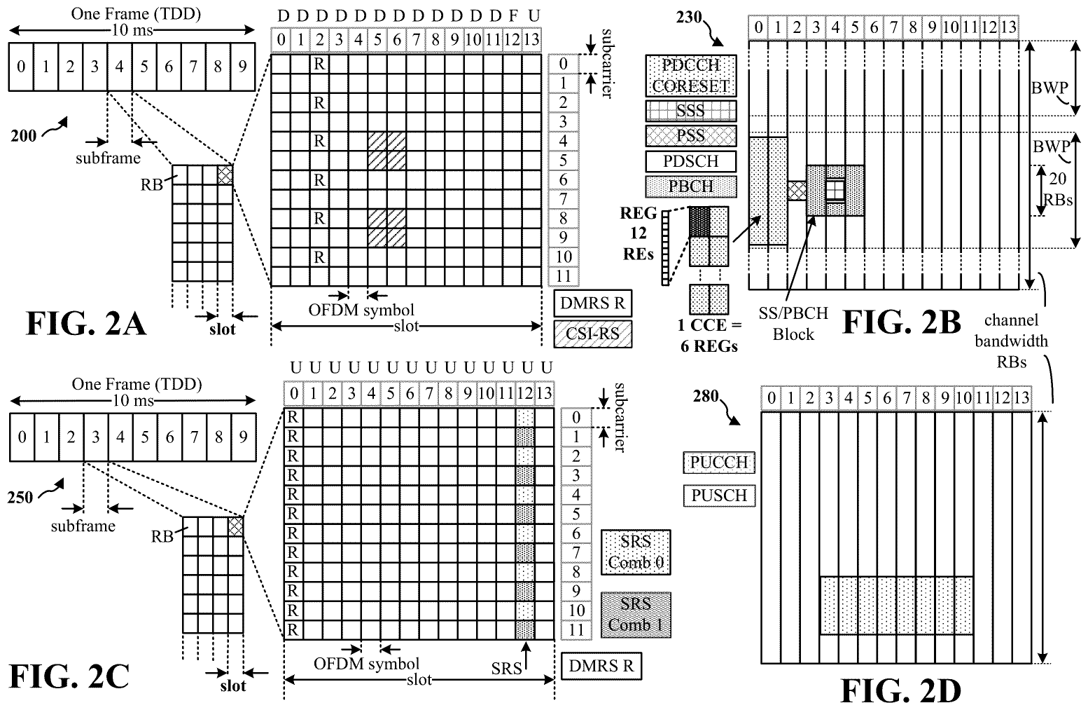

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| | Δf = 2^{μ} · 15 | Cyclic |
| μ | [kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

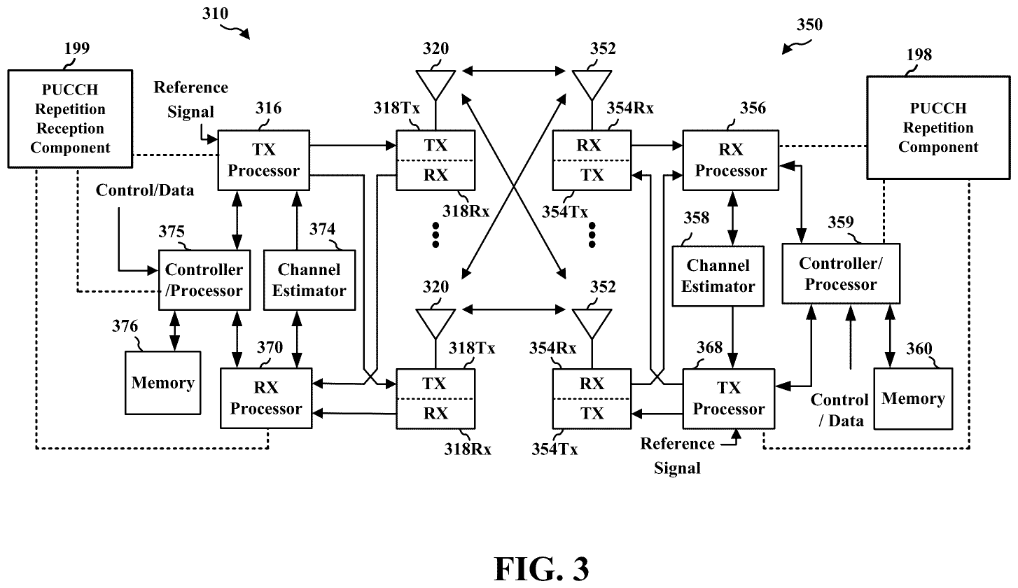

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PUCCH repetition component 198 of FIG. 1.

At least one of the TX processor 316, the RX processor 370, and the controller/processor 375 may be configured to perform aspects in connection with the PUCCH repetition reception component 199 of FIG. 1.

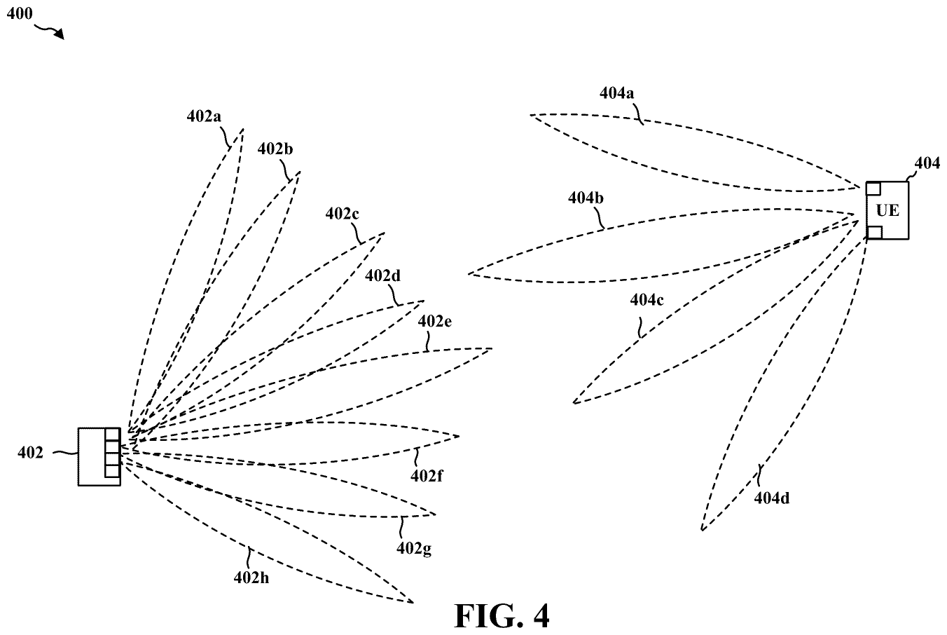

FIG. 4 is a diagram 400 illustrating a network entity, such as a base station 402 or a component of base station, in communication with a UE 404. Referring to FIG. 4, the base station 402 may transmit a beamformed signal to the UE 404 in one or more of the directions 402a, 402b, 402c, 402d, 402e, 402f, 402g, 402h. The UE 404 may receive the beamformed signal from the base station 402 in one or more receive directions 404a, 404b, 404c, 404d. The UE 404 may also transmit a beamformed signal to the base station 402 in one or more of the directions 404a-404d. The base station 402 may receive the beamformed signal from the UE 404 in one or more of the receive directions 402a-402h. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same.

In response to different conditions, the UE 404 may determine to switch beams, e.g., between beams 402a-402h. The beam at the UE 404 may be used for reception of downlink communication and/or transmission of uplink communication. In some examples, the base station 402 may send a transmission that triggers a beam switch by the UE 404. For example, the base station 402 may indicate a transmission configuration indication (TCI) state change, and in response, the UE 404 may switch to a new beam for the new TCI state of the base station 402. In some instances, a UE may receive a signal, from a base station, configured to trigger a transmission configuration indication (TCI) state change via, for example, a MAC control element (CE) command. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication.

The base station 402 and the UE 404 may each include multiple transmission reception points (TRPs). Each TRP may include different RF modules having a shared hardware and/or software controller. Each TRP may perform separate baseband processing. Each TRP may include a different antenna panel or a different set of antenna elements.

A base station may configure one or more reference signals, such as a CSI-RS or SSB, for the UE to use to perform CSI measurements. The UE may receive configurations such as a CSI resource set, a CSI-resource configuration, a CSI measurement configuration etc. A CSI resource may indicate a physical location, e.g., in time, frequency, or spatial direction, of a CSI related reference signal. A CSI resource set may correspond to a group of CSI-RS resources. A CSI resource configuration may indicate a type of reference signal that the network will transmit, e.g., a CSI-RS, SSB, etc.; and a transmission type, e.g., aperiodic, periodic, semipersistent, etc. The network may also configure the UE with a CSI report configuration that indicates a report period, quantity or information to be reported, trigger condition, codebook configuration, etc. for the UE to use to provide or report CSI to the network. CSI may include channel quality information (CQI), precoding matrix indicator (PMI), CSI-RS resource indictor (CRI), an SS/PBCH resource block indicator (SSBRI), a layer indicator (LI), rank indicator (RI), and/or an L1-RSRP. The UE may perform the measurements of the reference signals indicated by the network and may report the resulting measurements to the network. In response to the CSI from the UE, the network may adjust physical or MAC layer parameters, e.g., such as MCS, an antenna configuration, a CSI codebook, etc.

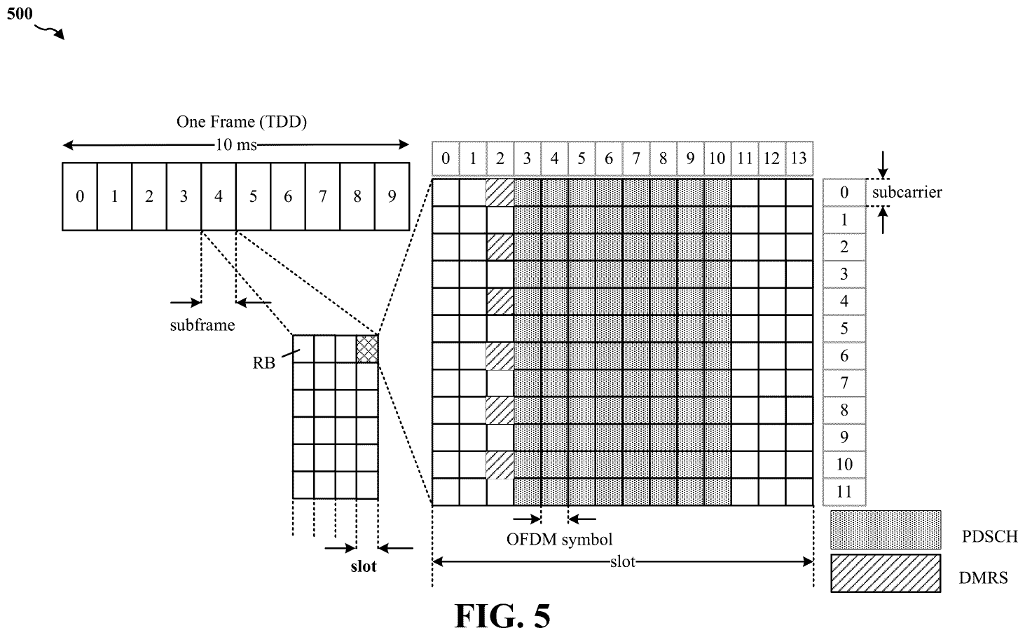

In some aspects, a CSI refinement or CSI adjustment may be based on another downlink reference signal. As one example, a CSI refinement may be based on a measurement of a demodulation reference signal (DMRS) of a downlink transmission, such as DMRS transmitted in a PDSCH transmission. Although the DMRS may be included in the PDSCH to assist the UE in decoding the PDSCH, the UE may use the DMRS to perform a CSI measurement, and may report the CSI to the network based on the measurement of the DMRS. FIG. 5 illustrates an example resource structure 500 showing an example of resources for a PDSCH transmission and associated DMRS. The example in FIG. 5 is merely one of various resource configurations that may be used for the DMRS and PDSCH. The DMRS may have a different pattern in time and/or frequency and may be transmitted in more than one OFDM symbol. The use of the DMRS to perform the CSI measurement and CSI refinement enables the UE to provide the network with refined, or adjusted, CSI information without additional overhead for an additional reference signal, such as CSI-RS or SSB, by using the DMRS that is transmitted with the PDSCH for decoding purposes.

In some aspects, the UE may report the CSI refinement information, e.g., based on the measurement of the DMRS, to the base station along with HARQ-ACK feedback for the PDSCH. For example, the CSI refinement information may be included in UCI in the PUCCH resources associated with the PDSCH. In some aspects, the UE may report a delta CQI, e.g., a difference relative to a previously reported CQI, as the CSI refinement information. As an example, the UE may report a delta L1-RSRP to the network. A delta L1-RSRP may correspond to a difference relative to a previously reported L1-RSRP. For example, if the UE previously reports L1-RSRP₁, and the UE measures L1-RSRP₂ based on the DMRS of the PDSCH, the UE may report the delta L1-RSRP, in which ΔL1-RSRP=L1-RSRP₂−L1-RSRP₁, for example.

If the CSI refinement information is transmitted together with the HARQ-ACK feedback, the overall size of the UCI that includes the HARQ-ACK feedback and the CSI refinement information is increased. The PUCCH resources that the UE is to use to transmit the UCI may be dependent on the size of the UCI. For example, there may be different PUCCH resource sets for different sizes of UCI. If the UE includes the CSI refinement information with the HARQ-ACK information, the UE may then transmit the resulting UCI in a different PUCCH resource set than the UE would use to transmit the UCI including the HARQ-ACK feedback and without the CSI refinement information, based on the increased size of the UCI. The use of a different resource set to transmit the HARQ-ACK based on the increase of size due to the addition of the CSI refinement information may cause complications in connection with the PUCCH resources. Additionally, for UEs in limited coverage, which may be referred to as coverage-limited UEs, separate transmissions of the CSI information (e.g., delta CQI or delta L1-RSRP) and HARQ-ACK feedback may provide improved accuracy of communication. For example, the separate transmissions may provide better coverage for the UE as the separate transmissions may have different coverage. As well, the separate transmissions may avoid decoding errors due to the combination of information carried in a combined UCI.

The UE may be indicated to provide PUCCH repetition to the network. For example, the UE may transmit a repetition of UCI to the network. In some aspects, the UE may be configured with PUCCH resources for PUCCH repetition, e.g., to transmit repetitions of UCI carrying HARQ-ACK for a PDSCH. In some aspects, the UE may receive a dynamic indication of PUCCH repetition. For example, the UE may receive DCI scheduling a PDSCH, and the DCI may include an indication for the UE to apply PUCCH repetition when reporting the HARQ-ACK for the PDSCH. In response to the indication in the DCI, the UE may transmit an initial transmission of the UCI carrying the HARQ-ACK information in a first PUCCH resource and one or more repetitions of the UCI carrying the HARQ-ACK information for the PDSCH in additional PUCCH resources. In some aspects, the indication in the DCI may be included in a PUCCH resource indicator (PRI), e.g., a PRI bitfield of the scheduling DCI. In some aspects, a parameter for the PUCCH repetition resources, such as “PUCCH-nrofSlots” may be configured per PUCCH resource to allow for dynamic indications of PUCCH repetition in DCI, whereas a parameter such as “PUCCH-nrofSlots” may be configured per PUCCH format to allow for a semi-static indication of PUCCH repetition to the UE. In some aspects, the “PUCCH-nrofSlots” configured per PUCCH resource may be referred to by a different name than the parameter that is configured per PUCCH format, such as by “PUCCH-nrofSlots-r17”.

Aspects presented herein provide for an interaction of CSI refinement/adjustment, which may be transmitted with HARQ-ACK information for a PDSCH, with PUCCH repetition associated with the PDSCH. The use of different subsets of PUCCH repetition resources for HARQ-ACK and CSI refinement information may help to reduce the size of the UCI transmitted and may improve coverage of the transmissions through separating the HARQ-ACK information and the CSI refinement information.

If the UE receives an indication for PUCCH repetition for a scheduled PDSCH, the UE may use the two, different subsets of the PUCCH resources differently. The UE may use a first subset of resources for HARQ-ACK and second set of resources for the CSI refinement information. As an example, if the PUCCH repetition resources are for multiple slots, the UE may divide the slots into two subsets: one subset for transmission of HARQ-ACK associated with the PDSCH, and another subset for transmission of CSI refinement/adjustment information, which may be based on DMRS measurements of the PDSCH. The two subsets of resources may include different, non-overlapping subsets of resources

The UE may obtain the CSI refinement/adjustment based on DMRS of the scheduled PDSCH, and may transmit the CSI refinement/adjustment information on the same PUCCH resources as indicated by the PRI in the DCI scheduling the PDSCH. In some aspects, the UE may use another indicator, such as the CCE index of the scheduling PDCCH to determine to transmit the CSI refinement information in a subset of the PUCCH repetition resources. In some aspects, the UE may use the PRI in the DCI and the CCE index of the scheduling PDCCH to determine the resources of the PUCCH repetition to use to transmit the CSI refinement information.

The subset of resources or the number of slots that the UE may use for transmission and/or repetition of CSI refinement information may be configured for the UE by RRC. In some aspects, the resources to be used for the transmission and/or repetition of the CSI refinement information with PUCCH repetition may be configured per PUCCH resource. The configuration per PUCCH resource may allow the network to dynamically indicate a particular configuration via PRI by indicating the corresponding PUCCH resource.

In some aspects, the resources to be used for the transmission and/or repetition of the CSI refinement information with PUCCH repetition may be configured per PUCCH format. The configuration per PUCCH format may allow the network to indicate a particular configuration in semi-static manner.

The subset of PUCCH repetition resources or the number of slots used for the transmission and/or the repetition of the CSI refinement/adjustment information may be determined based on a configured rule (e.g., which may be a preconfigured rule) and/or a defined rule that may be based on a wireless standard or other known rule. As an example, the rule may be based on a parameter such as “PUCCH-nrofSlots” that is configured per PUCCH resource, which may be referred to as “PUCCH-nrofSlotsr17” or “PUCCH-nrofSlots” that is configured per PUCCH format. As one, non-limiting example of a rule, the resources for the CSI refinement information may be half (or some other fraction) of the indicated value for “PUCCH-nrofSlots” or “PUCCH-nrofSlots-r17). In some aspects, there may be an additional condition, e.g., the resources for the CSI refinement being half if “PUCCH-nrofSlots-r17”>k, where k may be a parameter configured by the network.

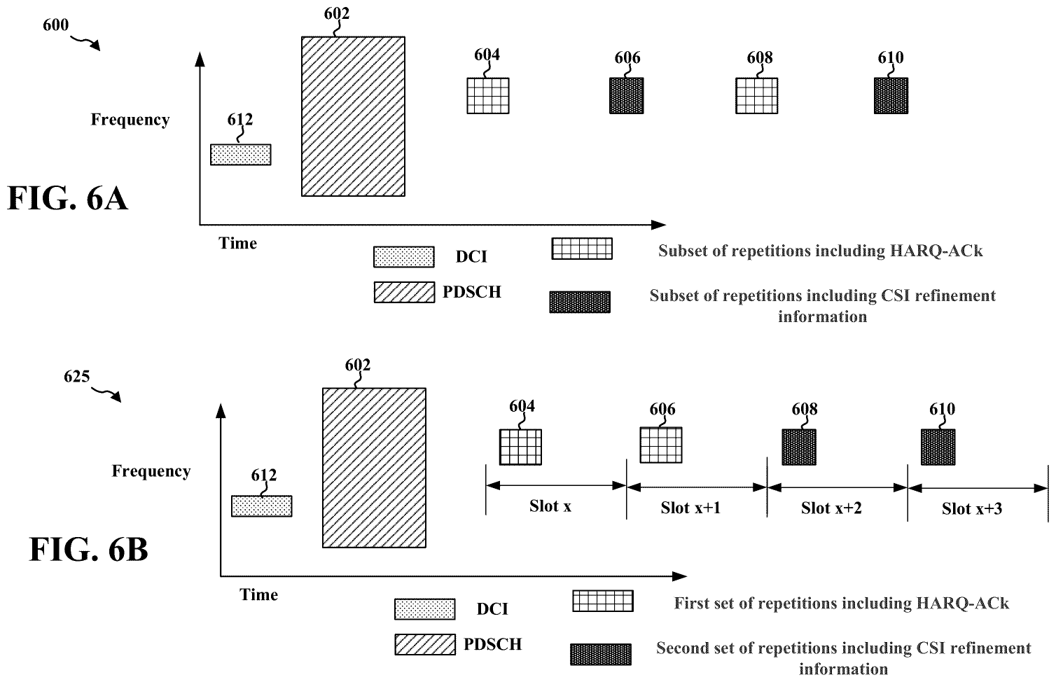

FIG. 6A and FIG. 6B illustrates example resource diagrams 600 and 625 showing that the UE may use PUCCH repetition resources 604, 606, 608, and 610 associated with a PDSCH transmission 602 that is scheduled by DCI 612 to separately transmit HARQ-ACK and CSI refinement information in different PUCCH repetition resources. FIG. 6A illustrates an example alternating pattern for the transmission of the HARQ-ACK and CSI refinement information in the PUCCH repetition resources. FIG. 6B illustrates an example in which the HARQ-ACK is transmitted in a first subset of PUCCH repetition resources and the CSI refinement information in a second subset of the PUCCH repetition resources after the HARQ-ACK. FIG. 6B illustrates that the PUCCH repetition resources 604, 606, 608, and 610 may be the same scheduled resource (e.g., a same set of one or more resource blocks and a same set of one or more symbols) in multiple slots. The examples in FIGS. 6A and 6B are merely to illustrate the concept. The subsets of PUCCH repetition resources may be divided differently, e.g., with three transmissions of HARQ-ACK and one transmission of CSI refinement information or with three transmissions of CSI refinement information and a single transmission of HARQ-ACK. As well, the PUCCH repetition resources may be provided for a different number of slots, such as two or more slots. As well, the CSI refinement may be transmitted in PUCCH repetition resources before the HARQ-ACK.

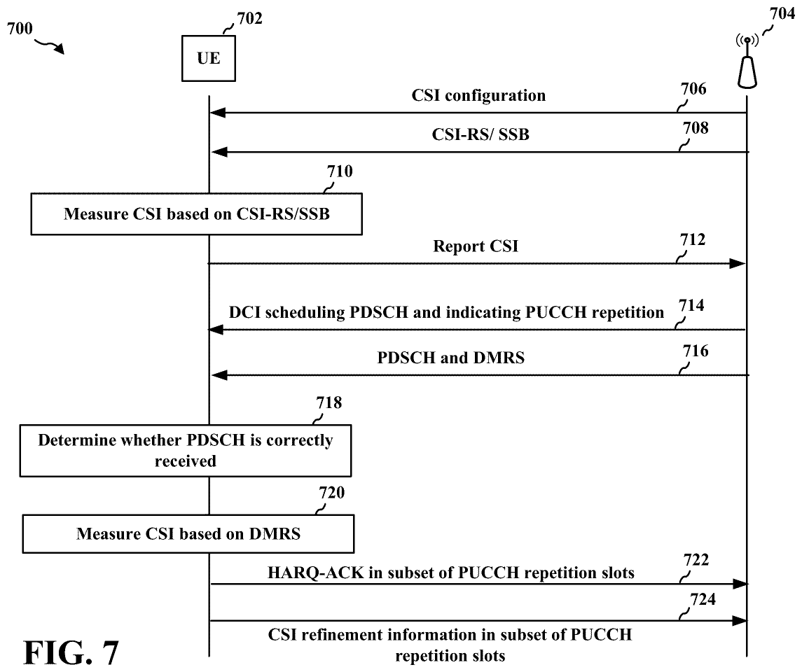

FIG. 7 illustrates an example communication flow 700 between a UE 702 and a base station 704. One or more of the aspects described for the base station 704 may be performed by the base station in aggregated form or a component of a disaggregated base station, such as a CU 110, DU 130, or RU 140. As illustrated at 706, the base station may configure the UE, e.g., in RRC signaling, with a CSI configuration. The CSI configuration may indicate a reference signal for the UE 702 to use to obtain the CSI, resource on which the UE is to measure CSI, and/or parameters for reporting the CSI. The base station may transmit a downlink reference signal 708, such as a CSI-RS or SSB that the UE may measure, at 710, to obtain the CSI. The UE 702 may then report the CSI to the base station at 712. The CSI that the UE reports to the base station may include a CQI or an L1-RSRP, among other types of CSI.

At 714, the base station may schedule a PDSCH for the UE 702. The base station may transmit DCI scheduling the PDSCH, and may indicate for the UE to use PUCCH repetition associated with the PDSCH. For example, the DCI may include a PRI that indicates for the UE to use PUCCH repetition to transmit one or more repetitions of HARQ-ACK for the PDSCH. The UE 702 may receive the PDSCH and associated DMRS, at 716. FIG. 5 illustrates example aspects of PDSCH and DMRS.

At 718, the UE may determine whether the PDSCH is accurately received, e.g., in order to provide ACK/NACK feedback for the PDSCH. At 720, the UE may measure CSI based on the DMRS received with the PDSCH, at 716. At 722, the UE may transmit the HARQ-ACK feedback for the PDSCH in a subset of the PUCCH repetition resources. At 724, the UE may transmit the CSI refinement information in a different subset of PUCCH repetition resources. The CSI refinement information may include delta CSI in relation to the CSI reported at 712. As an example, the CSI refinement information may include a delta CQI or a delta L1-RSRP relative to the CSI reported at 712. The subsets of PUCCH repetition resources may include any of the aspects described in connection with FIG. 6A and FIG. 6B. In some aspects, the CSI configuration, at 706 may indicate one or more parameters that the UE may use to determine the subset of PUCCH repetition resources to use for the CSI refinement information. The parameter may be configured per PUCCH resource, which may allow for an indication in PRI in the DCI at 714, or per PUCCH format. For example, the subset of resources for the CSI refinement information may be a subset of the number of slots for the PUCCH repetition. In other aspects, the subset of the PUCCH repetition resources for the CSI refinement information may be based on a rule, such as being half (or another fraction) of the number of slots of the PUCCH repetition resources.

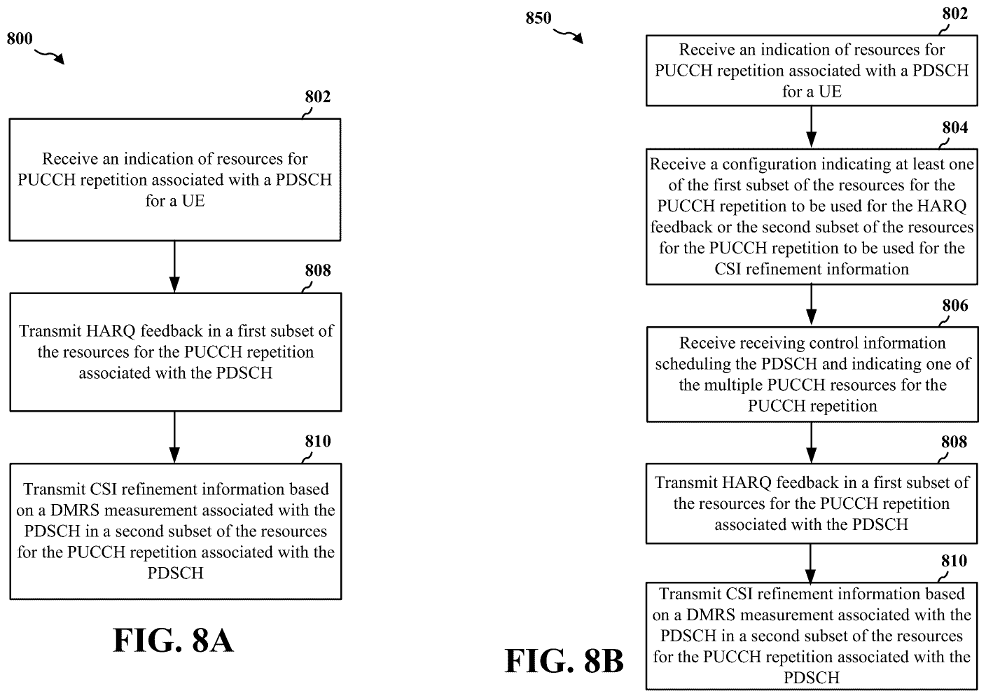

FIG. 8A is a flowchart 800 of a method of wireless communication. The method may be performed by a UE (e.g., the UE 104, 350, 702; the apparatus 904). The method may provide for the efficient use of PUCCH resources for PUCCH repetition when transmitting HARQ-ACK and CSI refinement information in UCI. The method may provide coverage improvement through the separate transmission of HARQ-ACK and CSI refinement information.

At 802, the UE receives an indication of resources for PUCCH repetition associated with a PDSCH. The reception may be performed, e.g., by the PUCCH repetition component 198. The indication of the resources for the PUCCH repetition may be included in DCI scheduling the PDSCH, such as a PRI in the DCI. For example, in FIG. 7, the indication may be received in the DCI at 714. The indication of the resources for the PUCCH repetition may be indicated by a control transmission scheduling the PDSCH. As an example, the indication may be based on a CCE index of the scheduling PDCCH, e.g., the PDCCH on which the DCI is received.

At 808, the UE transmits HARQ feedback in a first subset of the resources for the PUCCH repetition associated with the PDSCH. The transmission may be performed, e.g., by the PUCCH repetition component 198. FIG. 7 illustrates an example of the UE transmitting HARQ-ACK feedback at 722. FIGS. 6A and 6B illustrate examples of HARQ-ACK transmitted on a subset of PUCCH repetition resources.

At 810, the UE transmits CSI refinement information based on a DMRS measurement associated with the PDSCH in a second subset of the resources for the PUCCH repetition associated with the PDSCH. The first subset of resources is different than the second subset of resources, e.g., and may be non-overlapping to the second subset of resources. For example, the two subsets of resources may be mutually exclusive of the other set of resources. The transmission may be performed, e.g., by the PUCCH repetition component 198. In some aspects, the first subset of the resources may include a first set of one or more slots for the PUCCH repetition, and the second subset of the resources may include a second set of one or more slots for the PUCCH repetition. In some aspects, the indication of the resources for the PUCCH repetition may indicate a number of slots for the PUCCH repetition, and the second subset of the resources for the CSI refinement information includes a subset of the number of slots based on a rule. FIG. 7 illustrates an example of the UE transmitting the CSI refinement information at 724. FIGS. 6A and 6B illustrate examples of CSI refinement information transmitted on a subset of PUCCH repetition resources.

FIG. 8B is a flowchart 850 of a method of wireless communication. The method may be performed by a UE (e.g., the UE 104, 350, 702; the apparatus 904). The method may provide for the efficient use of PUCCH resources for PUCCH repetition when transmitting HARQ-ACK and CSI refinement information in UCI. The may provide coverage improvement through the separate transmission of HARQ-ACK and CSI refinement information. The method may include any of the aspects performed by the UE 702 in FIG. 7.

At 802, the UE receives an indication of resources for PUCCH repetition associated with a PDSCH. The reception may be performed, e.g., by the PUCCH repetition component 198. The indication of the resources for the PUCCH repetition may be included in DCI scheduling the PDSCH, such as a PRI in the DCI. The indication of the resources for the PUCCH repetition may be indicated by a control transmission scheduling the PDSCH. As an example, the indication may be based on a CCE index of the scheduling PDCCH.

As illustrated at 804, the UE may receive a configuration indicating at least one of the first subset of the resources for the PUCCH repetition to be used for the HARQ feedback or the second subset of the resources for the PUCCH repetition to be used for the CSI refinement information. The reception may be performed, e.g., by the PUCCH repetition component 198. For example, a number of slots for the CSI refinement may be configured for the UE. The configuration may be comprised in RRC signaling. In some aspects, the configuration indicates at least one of the first subset of the resources or the second subset of the resources for each of one or more PUCCH formats, e.g., per PUCCH format.

The configuration indicates at least one of the first subset of the resources or the second subset of the resources for each of multiple PUCCH resources, e.g., per PUCCH resource. As illustrated at 806, the UE may receive control information scheduling the PDSCH and indicating one of the multiple PUCCH resources for the PUCCH repetition. The reception may be performed, e.g., by the PUCCH repetition component 198.

At 808, the UE transmits HARQ feedback in a first subset of the resources for the PUCCH repetition associated with the PDSCH. The transmission may be performed, e.g., by the PUCCH repetition component 198. FIG. 7 illustrates an example of the UE transmitting HARQ-ACK feedback at 722. FIGS. 6A and 6B illustrate examples of HARQ-ACK transmitted on a subset of PUCCH repetition resources.

At 810, the UE transmits CSI refinement information based on a DMRS measurement associated with the PDSCH in a second subset of the resources for the PUCCH repetition associated with the PDSCH. The first subset of resources is different than the second subset of resources, e.g., and may be non-overlapping to the second subset of resources. For example, the two subsets of resources may be mutually exclusive of the other set of resources. The transmission may be performed, e.g., by the PUCCH repetition component 198. In some aspects, the first subset of the resources may include a first set of one or more slots for the PUCCH repetition, and the second subset of the resources may include a second set of one or more slots for the PUCCH repetition. In some aspects, the indication of the resources for the PUCCH repetition may indicate a number of slots for the PUCCH repetition, and the second subset of the resources for the CSI refinement information includes a subset of the number of slots based on a rule. FIG. 7 illustrates an example of the UE transmitting the CSI refinement information at 724. FIGS. 6A and 6B illustrate examples of CSI refinement information transmitted on a subset of PUCCH repetition resources.

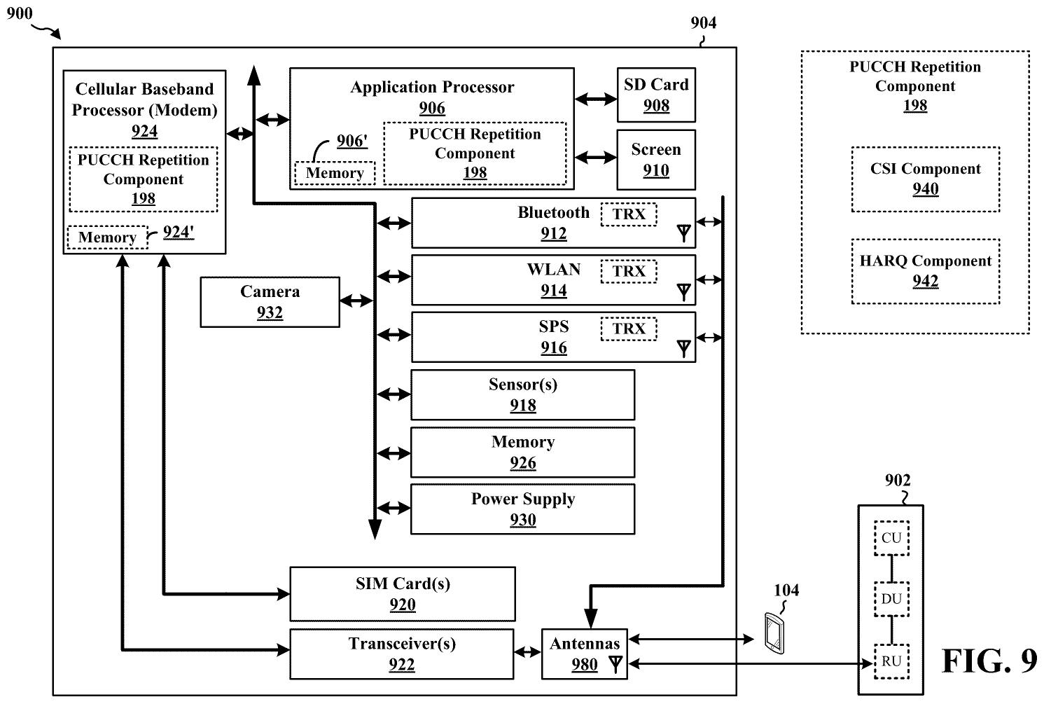

FIG. 9 is a diagram 900 illustrating an example of a hardware implementation for an apparatus 904. The apparatus 904 may be a UE, a component of a UE, or may implement UE functionality. In some aspects, the apparatus 904 may include a cellular baseband processor 924 (also referred to as a modem) coupled to one or more transceivers 922 (e.g., cellular RF transceiver). The cellular baseband processor 924 may include on-chip memory 924′. In some aspects, the apparatus 904 may further include one or more subscriber identity modules (SIM) cards 920 and an application processor 906 coupled to a secure digital (SD) card 908 and a screen 910. The application processor 906 may include on-chip memory 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules (e.g., memory 926), a power supply 930, and/or a camera 932. The Bluetooth module 912, the WLAN module 914, and the SPS module 916 may include an on-chip transceiver (TRX) (or in some cases, just a receiver (RX)). The Bluetooth module 912, the WLAN module 914, and the SPS module 916 may include their own dedicated antennas and/or utilize the antennas 980 for communication. The cellular baseband processor 924 communicates through the transceiver(s) 922 via one or more antennas 980 with the UE 104 and/or with an RU associated with a network entity 902. The cellular baseband processor 924 and the application processor 906 may each include a computer-readable medium/memory 924′, 906′, respectively. The additional memory modules, e.g., 926, may also be considered a computer-readable medium/memory. Each computer-readable medium/memory 924′, 906′, 926 may be non-transitory. The cellular baseband processor 924 and the application processor 906 are each responsible for general processing, including the execution of software stored on the computer-readable medium/memory. The software, when executed by the cellular baseband processor 924/application processor 906, causes the cellular baseband processor 924/application processor 906 to perform the various functions described supra. The computer-readable medium/memory may also be used for storing data that is manipulated by the cellular baseband processor 924/application processor 906 when executing software. The cellular baseband processor 924/application processor 906 may be a component of the UE 350 and may include the memory 360 and/or at least one of the TX processor 368, the RX processor 356, and the controller/processor 359. In one configuration, the apparatus 904 may be a processor chip (modem and/or application) and include just the cellular baseband processor 924 and/or the application processor 906, and in another configuration, the apparatus 904 may be the entire UE (e.g., see 350 of FIG. 3) and include the additional modules of the apparatus 904.

As discussed herein, the PUCCH repetition component 198 is configured to receive an indication of resources for PUCCH repetition associated with a PDSCH, transmit HARQ feedback in a first subset of the resources for the PUCCH repetition associated with the PDSCH; and transmit CSI refinement information based on a DMRS measurement associated with the PDSCH in a second subset of the resources for the PUCCH repetition associated with the PDSCH. In some aspects, the PUCCH reception component 198 may be further configured to receive a configuration indicating at least one of the first subset of the resources for the PUCCH repetition to be used for the HARQ feedback or the second subset of the resources for the PUCCH repetition to be used for the CSI refinement information. In some aspects, the PUCCH reception component 198 may be further configured to receive control information scheduling the PDSCH and indicating one of the multiple PUCCH resources for the PUCCH repetition. In some aspects, the PUCCH repetition component 198 may include a CSI component 940 configured to transmit CSI refinement information based on a DMRS measurement associated with the PDSCH in a second subset of the resources for the PUCCH repetition associated with the PDSCH, and a HARQ component 942 configured to transmit HARQ feedback in a first subset of the resources for the PUCCH repetition associated with the PDSCH. The component 198 may be within the cellular baseband processor 924, the application processor 906, or both the cellular baseband processor 924 and the application processor 906. The PUCCH repetition component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 904 may include a variety of components configured for various functions. In one configuration, the apparatus 904, and in particular the cellular baseband processor 924 and/or the application processor 906, includes means for receiving an indication of resources for PUCCH repetition associated with a PDSCH, means for transmitting HARQ feedback in a first subset of the resources for the PUCCH repetition associated with the PDSCH, and means for transmitting CSI refinement information based on a DMRS measurement associated with the PDSCH in a second subset of the resources for the PUCCH repetition associated with the PDSCH. The apparatus 904 may further include means for receiving a configuration indicating at least one of the first subset of the resources for the PUCCH repetition to be used for the HARQ feedback or the second subset of the resources for the PUCCH repetition to be used for the CSI refinement information. The apparatus 904 may further include means for receiving control information scheduling the PDSCH and indicating one of the multiple PUCCH resources for the PUCCH repetition. The apparatus 904 may include means for performing any of the aspects described in connection with FIG. 8A, 8B, or performed by the UE 702 in FIG. 7. The means may be the component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

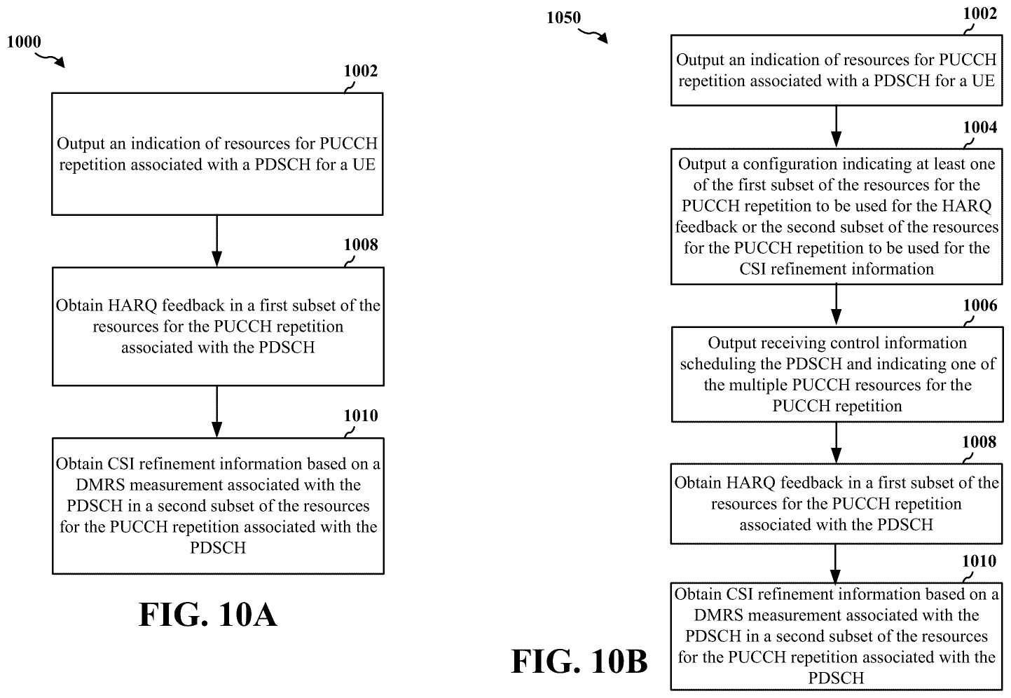

FIG. 10A is a flowchart 1000 of a method of wireless communication. The method may be performed by a network entity, such as a base station or a component of a base station (e.g., the base station 102, 310, 704; the CU 110; the DU 130; the RU 140; the network entity 902). The method may provide for the efficient use of PUCCH resources for PUCCH repetition when transmitting HARQ-ACK and CSI refinement information in UCI. The may provide coverage improvement through the separate transmission of HARQ-ACK and CSI refinement information. The method may further include any of the aspects performed by the base station in FIG. 7.

At 1002, the network entity outputs an indication of resources for PUCCH repetition associated with a PDSCH for a UE. In some aspects, the network entity may transmit the indication to the UE. The indication of the resources for the PUCCH repetition may be included in DCI scheduling the PDSCH, such as a PRI in the DCI. The indication of the resources for the PUCCH repetition may be indicated by a control transmission scheduling the PDSCH. As an example, the indication may be based on a CCE index of the scheduling PDCCH. The output may be performed, e.g., by the PUCCH repetition reception component 199.

At 1008, the network entity obtains HARQ feedback in a first subset of the resources for the PUCCH repetition associated with the PDSCH. In some aspects, the network entity may receive the HARQ feedback from the UE. The obtaining may be performed, e.g., by the repetition reception component 199. FIG. 7 illustrates an example of the network receiving HARQ-ACK feedback at 722. FIGS. 6A and 6B illustrate examples of HARQ-ACK received on a subset of PUCCH repetition resources.

At 1010, the network entity obtains CSI refinement information based on a DMRS measurement associated with the PDSCH in a second subset of the resources for the PUCCH repetition associated with the PDSCH. The first subset of resources is different than the second subset of resources, e.g., and may be non-overlapping to the second subset of resources. For example, the two subsets of resources may be mutually exclusive of the other set of resources. In some aspects, the network entity may receive the CSI refinement information from the UE. In some aspects, the first subset of the resources may include a first set of one or more slots for the PUCCH repetition, and the second subset of the resources may include a second set of one or more slots for the PUCCH repetition. The obtaining may be performed, e.g., by the PUCCH repetition reception component 199. FIG. 7 illustrates an example of the network receiving CSI refinement information at 724. FIGS. 6A and 6B illustrate examples of CSI refinement information received on a subset of PUCCH repetition resources.

FIG. 10B is a flowchart 1050 of a method of wireless communication. The method may be performed by a network entity, such as a base station or a component of a base station (e.g., the base station 102, 310, 704; the CU 110; the DU 130; the RU 140; the network entity 902). The method may provide for the efficient use of PUCCH resources for PUCCH repetition when transmitting HARQ-ACK and CSI refinement information in UCI. The may provide coverage improvement through the separate transmission of HARQ-ACK and CSI refinement information. The method may further include any of the aspects performed by the base station in FIG. 7.

At 1002, the network entity outputs an indication of resources for PUCCH repetition associated with a PDSCH for a UE. In some aspects, the network entity may transmit the indication to the UE. The indication of the resources for the PUCCH repetition may be included in DCI scheduling the PDSCH, such as a PRI in the DCI. The indication of the resources for the PUCCH repetition may be indicated by a control transmission scheduling the PDSCH. As an example, the indication may be based on a CCE index of the scheduling PDCCH. The output may be performed, e.g., by the PUCCH repetition reception component 199.

As illustrated at 1004, the network entity may output a configuration indicating at least one of the first subset of the resources for the PUCCH repetition to be used for the HARQ feedback or the second subset of the resources for the PUCCH repetition to be used for the CSI refinement information. For example, the network entity may transmit the configuration to the UE. In some aspects, the configuration may be included in RRC signaling. The configuration may indicate at least one of the first subset of the resources or the second subset of the resources for each of one or more PUCCH formats, e.g., per PUCCH format. In some aspects, the indication of the resources for the PUCCH repetition may indicate a number of slots for the PUCCH repetition, and the second subset of the resources for the CSI refinement information may include a subset of the number of slots based on a rule. The output may be performed, e.g., by the PUCCH repetition reception component 199.

The configuration may indicate at least one of the first subset of the resources or the second subset of the resources for each of multiple PUCCH resources, e.g., per PUCCH resource. As illustrated at 1006, the network entity may output control information scheduling the PDSCH and indicating one of the multiple PUCCH resources for the PUCCH repetition. For example, the network entity may transmit the control information to the UE. The output may be performed, e.g., by the PUCCH repetition reception component 199.

At 1008, the network entity obtains HARQ feedback in a first subset of the resources for the PUCCH repetition associated with the PDSCH. In some aspects, the network entity may receive the HARQ feedback from the UE. The obtaining may be performed, e.g., by the repetition reception component 199. FIG. 7 illustrates an example of the network receiving HARQ-ACK feedback at 722. FIGS. 6A and 6B illustrate examples of HARQ-ACK received on a subset of PUCCH repetition resources.

At 1010, the network entity obtains CSI refinement information based on a DMRS measurement associated with the PDSCH in a second subset of the resources for the PUCCH repetition associated with the PDSCH. The first subset of resources is different than the second subset of resources, e.g., and may be non-overlapping to the second subset of resources. For example, the two subsets of resources may be mutually exclusive of the other set of resources. In some aspects, the network entity may receive the CSI refinement information from the UE. In some aspects, the first subset of the resources may include a first set of one or more slots for the PUCCH repetition, and the second subset of the resources may include a second set of one or more slots for the PUCCH repetition. The obtaining may be performed, e.g., by the PUCCH repetition reception component 199. FIG. 7 illustrates an example of the network receiving CSI refinement information at 724. FIGS. 6A and 6B illustrate examples of CSI refinement information received on a subset of PUCCH repetition resources.

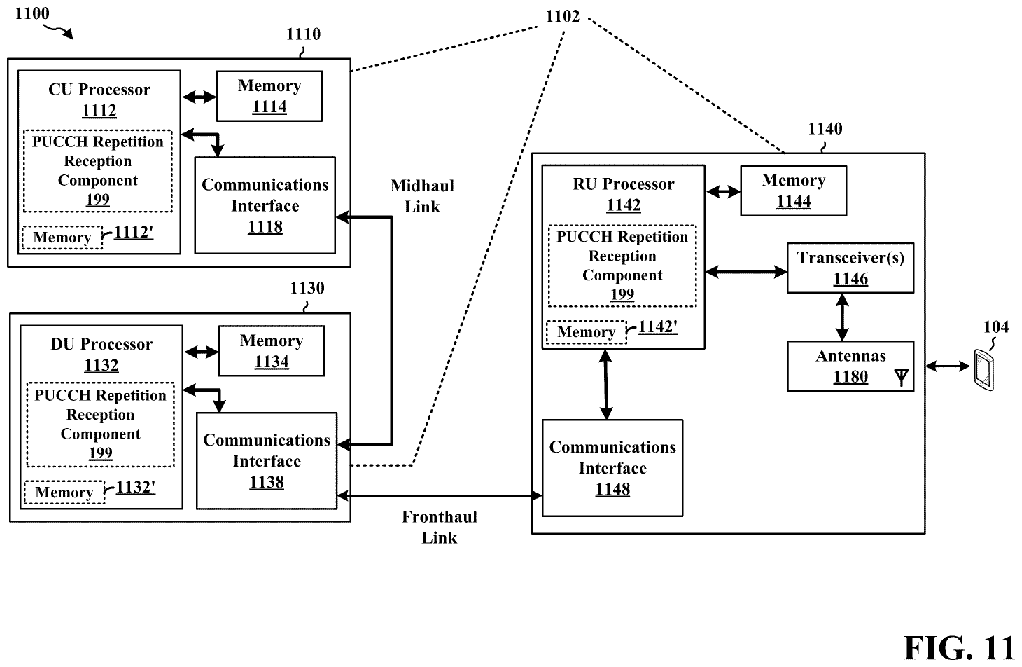

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed herein, the PUCCH repetition reception component 199 is configured to output an indication of resources for PUCCH repetition associated with a PDSCH for a UE, obtain HARQ feedback in a first subset of the resources for the PUCCH repetition associated with the PDSCH, and obtain CSI refinement information based on a DMRS measurement associated with the PDSCH in a second subset of the resources for the PUCCH repetition associated with the PDSCH. In some aspects, the PUCCH repetition reception component 199 may be further configured to output a configuration indicating at least one of the first subset of the resources for the PUCCH repetition to be used for the HARQ feedback or the second subset of the resources for the PUCCH repetition to be used for the CSI refinement information. In some aspects, the PUCCH repetition reception component 199 may be further configured to output control information scheduling the PDSCH and indicating one of the multiple PUCCH resources for the PUCCH repetition. The PUCCH repetition reception component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for outputting an indication of resources for PUCCH repetition associated with a PDSCH for a UE, means for obtaining HARQ feedback in a first subset of the resources for the PUCCH repetition associated with the PDSCH, and means for obtaining CSI refinement information based on a DMRS measurement associated with the PDSCH in a second subset of the resources for the PUCCH repetition associated with the PDSCH. The network entity may further include means for outputting a configuration indicating at least one of the first subset of the resources for the PUCCH repetition to be used for the HARQ feedback or the second subset of the resources for the PUCCH repetition to be used for the CSI refinement information. The network entity may further include means for outputting control information scheduling the PDSCH and indicating one of the multiple PUCCH resources for the PUCCH repetition. The network entity may include means for performing any of the aspects described in connection with FIG. 10A, 10B, or performed by the base station 704 in FIG. 7. The means may be the PUCCH repetition reception component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: receiving an indication of resources for PUCCH repetition associated with a PDSCH; transmitting HARQ feedback in a first subset of the resources for the PUCCH repetition associated with the PDSCH; and transmitting CSI refinement information based on a DMRS measurement associated with the PDSCH in a second subset of the resources for the PUCCH repetition associated with the PDSCH.

In aspect 2, the method of aspect 1 further includes that the first subset of the resources comprises a first set of one or more slots for the PUCCH repetition, and the second subset of the resources comprises a second set of one or more slots for the PUCCH repetition.

In aspect 3, the method of aspect 1 or aspect 2 further includes that the indication of the resources for the PUCCH repetition is comprised in DCI scheduling the PDSCH.

In aspect 4, the method of any of aspects 1-3 further includes that the indication of the resources for the PUCCH repetition is indicated by a control transmission scheduling the PDSCH.

In aspect 5, the method of any of aspects 1-4 further includes receiving a configuration indicating at least one of the first subset of the resources for the PUCCH repetition to be used for the HARQ feedback or the second subset of the resources for the PUCCH repetition to be used for the CSI refinement information.

In aspect 6, the method of aspect 5 further includes that the configuration is comprised in RRC signaling.

In aspect 7, the method of aspect 5 or aspect 6 further includes that the configuration indicates at least one of the first subset of the resources or the second subset of the resources for each of multiple PUCCH resources, the method further comprising: receiving control information scheduling the PDSCH and indicating one of the multiple PUCCH resources for the PUCCH repetition.

In aspect 8, the method of any of aspects 5-7 further includes that the configuration indicates at least one of the first subset of the resources or the second subset of the resources for each of one or more PUCCH formats.

In aspect 9, the method of any of aspects 5-8 further includes that the indication of the resources for the PUCCH repetition indicates a number of slots for the PUCCH repetition, and the second subset of the resources for the CSI refinement information includes a subset of the number of slots based on a rule.

Aspect 10 is an apparatus for wireless communication at a user equipment comprising means for performing the method of any of aspects 1-9.

In aspect 11, the apparatus of aspect 10 further includes at least one of a transceiver or an antenna.

Aspect 12 is an apparatus for wireless communication at a user equipment comprising memory and at least one processor coupled to the memory and configured to perform the method of any of aspects 1-9.

In aspect 13, the apparatus of aspect 12 further includes at least one of a transceiver or an antenna.

Aspect 14 is a non-transitory computer-readable medium storing computer executable code at a user equipment, the code when executed by a processor causes the processor to perform the method of any of aspects 1-9.

Aspect 15 is a method of wireless communication at a network entity, comprising: outputting an indication of resources for PUCCH repetition associated with a PDSCH for a UE; obtaining HARQ feedback in a first subset of the resources for the PUCCH repetition associated with the PDSCH; and obtaining CSI refinement information based on a DMRS measurement associated with the PDSCH in a second subset of the resources for the PUCCH repetition associated with the PDSCH.

In aspect 16, the method of aspect 15 further includes that the first subset of the resources comprises a first set of one or more slots for the PUCCH repetition, and the second subset of the resources comprises a second set of one or more slots for the PUCCH repetition.

In aspect 17, the method of aspect 15 or 16 further includes that the indication of the resources for the PUCCH repetition is comprised in DCI scheduling the PDSCH.

In aspect 18, the method of any of aspects 15-17 further includes that the indication of the resources for the PUCCH repetition is indicated by a control transmission scheduling the PDSCH.

In aspect 19, the method of any of aspects 15-18 further includes outputting a configuration indicating at least one of the first subset of the resources for the PUCCH repetition to be used for the HARQ feedback or the second subset of the resources for the PUCCH repetition to be used for the CSI refinement information.

In aspect 20, the method of aspect 19 further includes that the configuration is comprised in RRC signaling.

In aspect 21, the method of aspects 19 or 20 further includes that the configuration indicates at least one of the first subset of the resources or the second subset of the resources for each of multiple PUCCH resources, the method further comprising: outputting control information scheduling the PDSCH and indicating one of the multiple PUCCH resources for the PUCCH repetition.

In aspect 22, the method of any of aspects 19-21 further includes that the configuration indicates at least one of the first subset of the resources or the second subset of the resources for each of one or more PUCCH formats.

In aspect 23, the method of any of aspects 19-22 further includes that the indication of the resources for the PUCCH repetition indicates a number of slots for the PUCCH repetition, and the second subset of the resources for the CSI refinement information includes a subset of the number of slots based on a rule.

Aspect 24 is an apparatus for wireless communication at a user equipment comprising means for performing the method of any of aspects 15-23.

In aspect 25, the apparatus of aspect 24 further includes at least one of a transceiver or an antenna.

Aspect 26 is an apparatus for wireless communication at a user equipment comprising memory and at least one processor coupled to the memory and configured to perform the method of any of aspects 15-23.

In aspect 27, the apparatus of aspect 26 further includes at least one of a transceiver or an antenna.

Aspect 28 is a non-transitory computer-readable medium storing computer executable code at a user equipment, the code when executed by a processor causes the processor to perform the method of any of aspects 15-23.

What is claimed is:

1. An apparatus for wireless communication at a user equipment (UE), comprising:
memory; and
at least one processor coupled to the memory and configured to:
receive an indication of resources for physical uplink control channel (PUCCH) repetition associated with a physical downlink shared channel (PDSCH);
transmit hybrid automatic repeat request (HARQ) feedback in a first subset of the resources for the PUCCH repetition associated with the PDSCH; and
transmit channel state information (CSI) refinement information based on a demodulation reference signal (DMRS) measurement associated with the PDSCH in a second subset of the resources for the PUCCH repetition associated with the PDSCH.

2. The apparatus of claim 1, wherein the first subset of the resources comprises a first set of one or more slots for the PUCCH repetition, and the second subset of the resources comprises a second set of one or more slots for the PUCCH repetition.

3. The apparatus of claim 1, wherein the indication of the resources for the PUCCH repetition is comprised in downlink control information (DCI) scheduling the PDSCH.

4. The apparatus of claim 1, wherein the indication of the resources for the PUCCH repetition is indicated by a control transmission scheduling the PDSCH.

5. The apparatus of claim 1, wherein the at least one processor is further configured to:
receive a configuration indicating at least one of the first subset of the resources for the PUCCH repetition to be used for the HARQ feedback or the second subset of the resources for the PUCCH repetition to be used for the CSI refinement information.

6. The apparatus of claim 5, wherein the configuration is comprised in radio resource control (RRC) signaling.

7. The apparatus of claim 5, wherein the configuration indicates at least one of the first subset of the resources or the second subset of the resources for each of multiple PUCCH resources, wherein the at least one processor is further configured to:
receive control information scheduling the PDSCH and indicating one of the multiple PUCCH resources for the PUCCH repetition.

8. The apparatus of claim 5, wherein the configuration indicates at least one of the first subset of the resources or the second subset of the resources for each of one or more PUCCH formats.

9. The apparatus of claim 1, wherein the indication of the resources for the PUCCH repetition indicates a number of slots for the PUCCH repetition, and the second subset of the resources for the CSI refinement information includes a subset of the number of slots based on a rule.

10. The apparatus of claim 1, further comprising at least one transceiver coupled to the at least one processor and configured to receive the indication of the resources for the PUCCH repetition and to transmit the HARQ feedback and the CSI refinement information.

11. A method of wireless communication at a user equipment (UE), comprising:
receiving an indication of resources for physical uplink control channel (PUCCH) repetition associated with a physical downlink shared channel (PDSCH);
transmitting hybrid automatic repeat request (HARQ) feedback in a first subset of the resources for the PUCCH repetition associated with the PDSCH; and
transmitting channel state information (CSI) refinement information based on a demodulation reference signal (DMRS) measurement associated with the PDSCH in a second subset of the resources for the PUCCH repetition associated with the PDSCH.

12. The method of claim 11, wherein the first subset of the resources comprises a first set of one or more slots for the PUCCH repetition, and the second subset of the resources comprises a second set of one or more slots for the PUCCH repetition.

13. The method of claim 11, wherein the indication of the resources for the PUCCH repetition is comprised in downlink control information (DCI) scheduling the PDSCH.

14. The method of claim 11, wherein the indication of the resources for the PUCCH repetition is indicated by a control transmission scheduling the PDSCH.

15. The method of claim 11, further comprising:
receiving a configuration indicating at least one of the first subset of the resources for the PUCCH repetition to be used for the HARQ feedback or the second subset of the resources for the PUCCH repetition to be used for the CSI refinement information.

16. The method of claim 15, wherein the configuration is comprised in radio resource control (RRC) signaling.

17. The method of claim 15, wherein the configuration indicates at least one of the first subset of the resources or the second subset of the resources for each of multiple PUCCH resources, the method further comprising:
receiving control information scheduling the PDSCH and indicating one of the multiple PUCCH resources for the PUCCH repetition.

18. The method of claim 15, wherein the configuration indicates at least one of the first subset of the resources or the second subset of the resources for each of one or more PUCCH formats.

19. The method of claim 11, wherein the indication of the resources for the PUCCH repetition indicates a number of slots for the PUCCH repetition, and the second subset of the resources for the CSI refinement information includes a subset of the number of slots based on a rule.

20. An apparatus for wireless communication at a network entity, comprising:
memory; and
at least one processor coupled to the memory and configured to:
output an indication of resources for physical uplink control channel (PUCCH) repetition associated with a physical downlink shared channel (PDSCH) for a user equipment (UE);
obtain hybrid automatic repeat request (HARQ) feedback in a first subset of the resources for the PUCCH repetition associated with the PDSCH; and
obtain channel state information (CSI) refinement information based on a demodulation reference signal (DMRS) measurement associated with the PDSCH in a second subset of the resources for the PUCCH repetition associated with the PDSCH.

21. The apparatus of claim 20, wherein the first subset of the resources comprises a first set of one or more slots for the PUCCH repetition, and the second subset of the resources comprises a second set of one or more slots for the PUCCH repetition.

22. The apparatus of claim 20, wherein the indication of the resources for the PUCCH repetition is comprised in downlink control information (DCI) scheduling the PDSCH.

23. The apparatus of claim 20, wherein the indication of the resources for the PUCCH repetition is indicated by a control transmission scheduling the PDSCH.

24. The apparatus of claim 20, wherein the at least one processor is further configured to:
output a configuration indicating at least one of the first subset of the resources for the PUCCH repetition to be used for the HARQ feedback or the second subset of the resources for the PUCCH repetition to be used for the CSI refinement information.

25. The apparatus of claim 24, wherein the configuration is comprised in radio resource control (RRC) signaling.

26. The apparatus of claim 24, wherein the configuration indicates at least one of the first subset of the resources or the second subset of the resources for each of multiple PUCCH resources, wherein the at least one processor is further configured to:
output control information scheduling the PDSCH and indicating one of the multiple PUCCH resources for the PUCCH repetition.

27. The apparatus of claim 24, wherein the configuration indicates at least one of the first subset of the resources or the second subset of the resources for each of one or more PUCCH formats.

28. The apparatus of claim 20, wherein the indication of the resources for the PUCCH repetition indicates a number of slots for the PUCCH repetition, and the second subset of the resources for the CSI refinement information includes a subset of the number of slots based on a rule.

29. The apparatus of claim 20, further comprising at least one transceiver coupled to the at least one processor and configured to output the indication of the resources for the PUCCH repetition and to obtain the HARQ feedback and the CSI refinement information.

30. A method of wireless communication at a network entity, comprising:
outputting an indication of resources for physical uplink control channel (PUCCH) repetition associated with a physical downlink shared channel (PDSCH) for a user equipment (UE);
obtaining hybrid automatic repeat request (HARQ) feedback in a first subset of the resources for the PUCCH repetition associated with the PDSCH; and
obtaining channel state information (CSI) refinement information based on a demodulation reference signal (DMRS) measurement associated with the PDSCH in a second subset of the resources for the PUCCH repetition associated with the PDSCH.
